(19) United States
(12) Patent Application Publication
(10) Pub. No.: US 2012/0100512 A1
(43) Pub. Date: Apr. 26, 2012

(54) INSPECTION APPARATUS AND INSPECTION METHOD

(75) Inventor: Ryoji MOTOKI, Yokohama-shi (JP)

(73) Assignee: OLYMPUS CORPORATION, Tokyo (JP)

(21) Appl. No.: 12/911,842

(22) Filed: Oct. 26, 2010

(51) Int. Cl. G09B 19/00

(52) U.S. Cl. 434/219

(57) ABSTRACT

An inspection apparatus includes: a display, a display control section which displays, on a first surface area of the display, instructions for carrying out a plurality of inspection steps with the inspection apparatus, and which displays, on a second surface area of the display that is greater than the first surface area, instructions for carrying one of the inspection steps, and a controller which controls the display control section to display instructions for carrying a first one of the inspection steps on the second surface area before the first one of the inspection steps is performed, and to display instructions for carrying a second one of the inspection steps on the second surface area after the first one of the inspection steps is performed and before the second one of the inspection steps is performed.

### BACKGROUND OF THE INVENTION

1. Field of the Invention

The present invention relates to an inspection apparatus and an inspection method that are used in inspections which are based on an image of a subject.

2. Description of Related Art

In manufacturing processes for manufacturing various types of industrial products such as boilers, turbines, engines, pipes, and semiconductor components, inspections are performed in order to verify whether or not any defects are present in the product. In Unites States Patent Application Publication No. 2007/0225931, a technology is disclosed in which a procedure for a plurality of inspection steps is displayed on a monitor during an inspection. In this technology, when each inspection step is completed, a + sign is displayed next to numbers which show the sequence of the inspection steps in order to enable completed inspection steps to be distinguished from uncompleted inspection steps.

### SUMMARY OF THE INVENTION

An inspection apparatus according to an aspect of the present invention includes: a display, a display control section which displays, on a first surface area of the display, instructions for carrying out a plurality of inspection steps with the inspection apparatus, and which displays, on a second surface area of the display that is greater than the first surface area, instructions for carrying one of the inspection steps, and a controller which controls the display control section to display instructions for carrying a first one of the inspection steps on the second surface area before the first one of the inspection steps is performed, and to display instructions for carrying a second one of the inspection steps on the second surface area after the first one of the inspection steps is performed and before the second one of the inspection steps is performed.

### BRIEF DESCRIPTION OF THE DRAWINGS

FIG. 1 is a perspective view showing the overall structure of an endoscope apparatus according to an embodiment of the present invention.

FIG. 2 is a block diagram showing the internal structure of the endoscope apparatus according to the embodiment of the present invention.

FIG. 3 is a block diagram showing the function structure of a CPU provided in the endoscope apparatus according to the embodiment of the present invention.

FIG. 4 is a flowchart showing a first operation example of the endoscope apparatus according to the embodiment of the present invention.

FIG. 5 is a view showing a screen in the first operation example.

FIG. 6 is a view showing a screen in the first operation example.

FIG. 7 is a view showing a screen in the first operation example.

FIG. 8 is a view showing a screen in the first operation example.

FIG. 9 is a view showing a modified version of a screen in the first operation example.

FIG. 10 is a flowchart showing a second operation example of the endoscope apparatus according to the embodiment of the present invention.

FIG. 11 is a view showing a screen in the second operation example.

FIG. 12 is a flowchart showing a third operation example of the endoscope apparatus according to the embodiment of the present invention.

FIG. 13 is a view showing a screen in the third operation example.

FIG. 14 is a view showing a screen in the third operation example.

FIG. 15 is a view showing a screen in the third operation example.

FIG. 16 is a view showing a screen in the third operation example.

FIG. 17 is a view showing a screen in the third operation example.

FIG. 18 is a view showing a screen in the third operation example.

FIG. 19 is a view showing a screen in the third operation example.

FIG. 20 is a flowchart showing a fourth operation example of the endoscope apparatus according to the embodiment of the present invention.

FIG. 21 is a flowchart showing a procedure of the fourth operation example.

FIG. 22 is a view showing a screen in the fourth operation example.

FIG. 23 is a flowchart showing a fifth operation example of the endoscope apparatus according to the embodiment of the present invention.

FIG. 24 is a flowchart showing a procedure of the fifth operation example.

FIG. 25 is a view showing a screen in the fifth operation example.

FIG. 26 is a view showing a screen in the fifth operation example.

FIG. 27 is a view illustrating a method used to determine three-dimensional coordinates of a measurement point using stereo measurement.

### DETAILED DESCRIPTION OF THE INVENTION

Embodiments of the present invention will be described with reference made to the drawings. Hereinafter, an endoscope apparatus having a measurement function for measuring the size of a subject using an image of the subject is described as an example of an inspection apparatus. Recently, advances have been made in the miniaturization of inspection apparatuses and there are numerous inspection apparatuses that use a small-screen display portion. If an inspection procedure is displayed on the limited display region of a small-screen display portion, there is a marked deterioration in the viewability of the inspection procedure, and there is a possibility that an inspector will not be able to satisfactorily verify the inspection procedure and will carry out an inspection while following an incorrect inspection procedure. If an inspector performs an inspection based on an incorrect inspection procedure, it becomes necessary for the inspection to be performed once again with the correct procedure being followed. This results in the overall inspection work time being lengthened and leads to a reduction in work efficiency. In the inspection apparatus of the present embodiment, during an inspection procedure, information about an inspection step is displayed immediately prior to that inspection step or while that inspection step is being carried out. Consequently, it is possible to provide information about an inspection step to be performed to the inspector in an easily understood form.

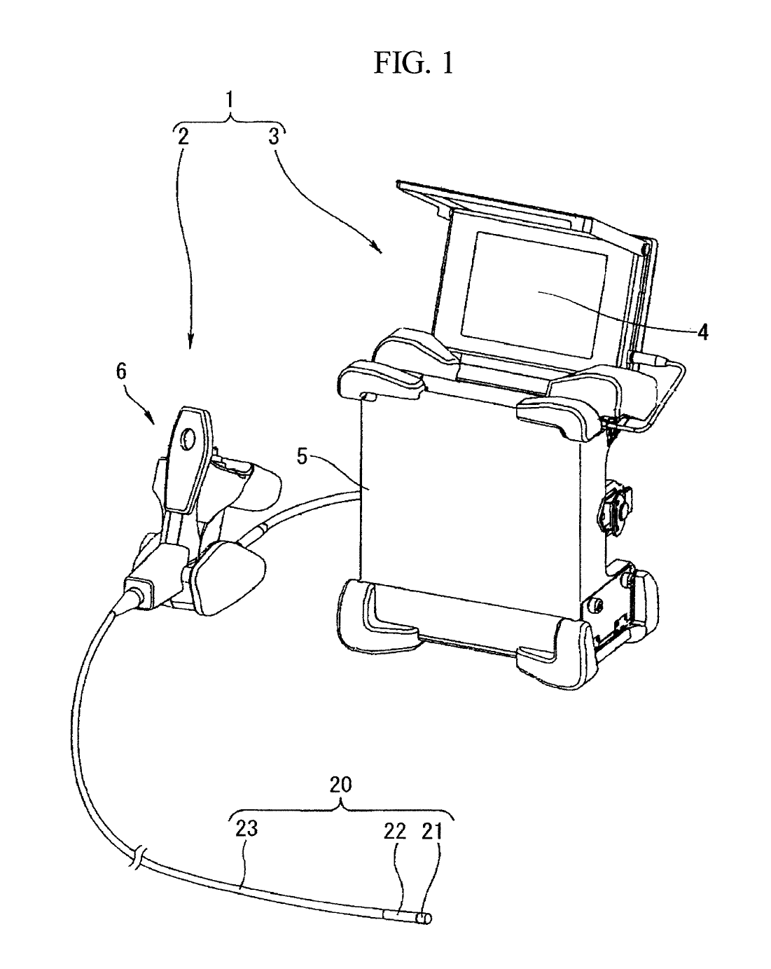

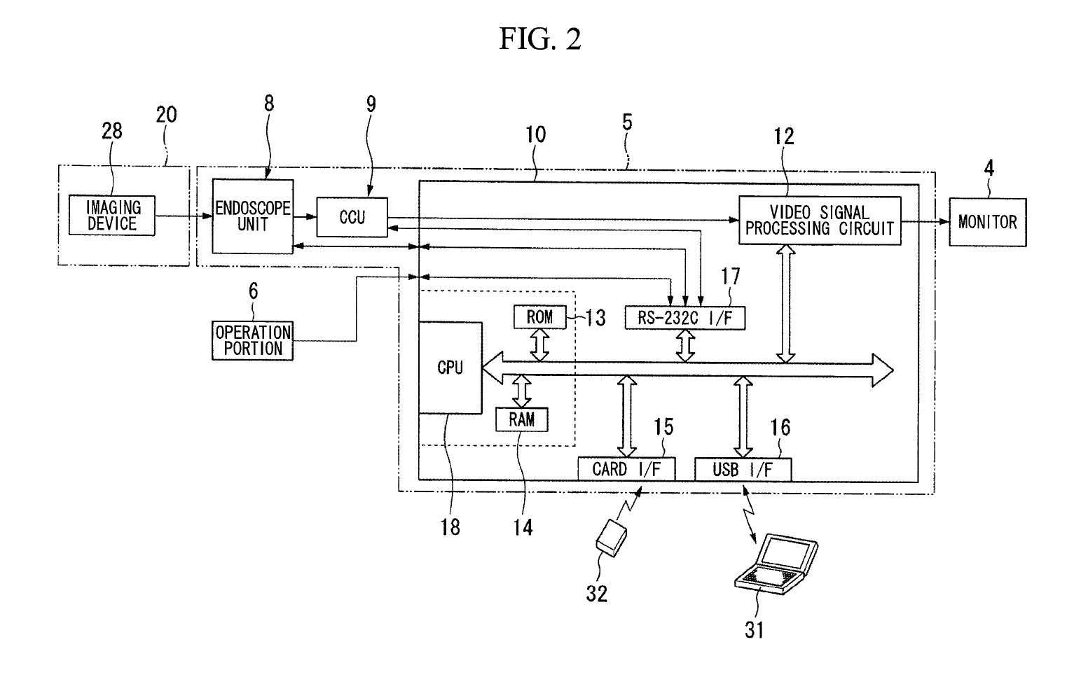

FIG. 1 shows the structure of an endoscope apparatus. As is shown in FIG. 1, an endoscope apparatus 1 is provided with an endoscope 2, and an apparatus main body 3 which is connected to this endoscope 2. The endoscope 2 is provided with a narrow, elongated insertion portion 20, and an operation portion 6 (i.e., an input device) that is used to perform an operation required in executing various kinds of operation controls of the entire apparatus. The apparatus main body 3 is provided with a monitor 4 (a liquid crystal monitor) which is a display device that displays images of a subject which has been acquired by the endoscope 2, and also displays operation control contents (for example, processing menus) and the like, and with a housing 5 which internally houses a control unit 10 (see FIG. 2).

The insertion portion 20 is formed by linking together in the following order from the distal end side a rigid distal end portion 21, a bent portion 22 capable of being bent, for example, in the vertical and horizontal directions, and a flexible tube portion 23 which is formed from a pliable material. Various kinds of optical adapters, such as a stereo optical adapter having two observation fields of view or a normal observation optical adapter having one observation field of view, can be attached to the distal end portion 21 in a freely detachable manner. In the present embodiment, at the time of measurement, a left image and a right image which are a pair of left and right subject images are acquired via a stereo optical adaptor which is capable of forming two subject images relating to the same subject.

As is shown in FIG. 2, an endoscope unit 8, a CCU 9 (i.e., a camera control unit), and a control unit 10 are provided inside the housing 5. A proximal end portion of the insertion portion 20 is connected to the endoscope unit 8. The endoscope unit 8 includes a light source driving device that drives a light source (for example, an LED) that is built in the distal end portion 21, and a bending device that bends the bent portion 22 which constitutes part of the insertion portion 20.

An imaging device 28 and the LED are built in the distal end portion 21. The imaging device 28 photoelectrically converts a subject image obtained via an optical adaptor to create an image signal. The image signal output from the imaging device 28 is input into the CCU 9. The image signal is converted into a video signal (i.e., image data) such as an NTSC signal in the CCU 9, and is then supplied to the control unit 10. The LED generates illumination light which is irradiated onto a subject. In the present embodiment, the LED is built in the distal end portion 21, however, the LED may be placed inside the housing 5, and the illumination light generated by the LED may be guided to the distal end portion 21 via an optical fiber. Illumination devices other than the LED may be used as a light source.

A video signal processing circuit 12 to which the video signal is input, a ROM 13, a RAM 14, a card I/F 15 (card interface), a USB I/F 16 (USB interface), an RS-232C I/F 17 (RS-232C interface), and a CPU 18 that executes various functions based on a main program stored in the ROM 13 and that performs various controls are provided in the control unit 10.

The CCU 9 and the endoscope unit 8 are connected to the RS-232C I/F 17. In addition, the operation portion 6 which performs control and operation instructions of the CCU 9, endoscope unit 8, and the like is connected to the RS-232C I/F 17. When a user operates the operation portion 6, a communication required for controlling the CCU 9 and the endoscope unit 8 is performed based on the operation contents.

The USB I/F 16 is an interface that electrically connects the control unit 10 and a personal computer 31 to each other. By connecting the control unit 10 to the personal computer 31 through the USB I/F 16, various kinds of instruction and controls, such as an instruction to display an endoscope image and image processing at the time of measurement, can be performed at the side of the personal computer 31. In addition, input and output of control information, data, and the like, which are required for various processing, between the control unit 10 and the personal computer 31 can be performed.

A memory card 32 can be freely attached to or detached from the card I/F 15. By mounting the memory card 32 in the card I/F 15, it is possible to take data, such as control processing information or image information, stored in the memory card 32 into the control unit 10, or to record data, such as the control processing information or the image information, in the memory card 32, in accordance with control of the CPU 18.

In order to display a synthesized image obtained by synthesizing an endoscope image based on the video signal supplied from the CCU 9 with a graphic image such as an operation menu, the video signal processing circuit 12 performs processing for synthesizing a graphic image signal generated by the control of the CPU 18 with the video signal from the CCU 9, processing required for displaying the synthesized image on the screen of the monitor 4, and the like, and supplies the display signal to the monitor 4. In addition, the video signal processing circuit 12 may also perform processing for simply displaying an endoscope image or an operation menu image, independently. Accordingly, the endoscope image, the operation menu image, the synthesized image obtained by synthesizing the endoscope image with the operation menu image, and the like, are displayed on the screen of the monitor 4.

The CPU 18 controls the overall operations of the endoscope apparatus 1 by executing a program stored in the ROM 13 in order to control various circuit portions to perform desired processing. The CPU 18 uses the RAM 14 as a working area for temporarily storing data.

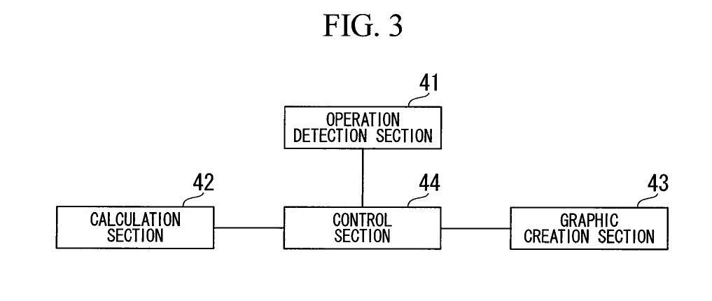

FIG. 3 shows the function structure of the CPU 18. An operation detection section 41 detects the type of operation of the operation portion 6 input by a user. A calculation section 42 performs processing to calculate three-dimensional coordinates based on the principle of triangulation, and also performs processing to calculate the length, the surface area and the like of a subject. A graphic creation section 43 creates a graphic image signal that is used to display various types of information which are displayed using characters, numbers or the like on a display screen, and to display cursor icons and the like. A control section 44 controls the allocation of processing to each one of the operation detection section 41, the calculation section 42, and the graphic creation section 43, and also controls the overall operations of the endoscope apparatus 1.

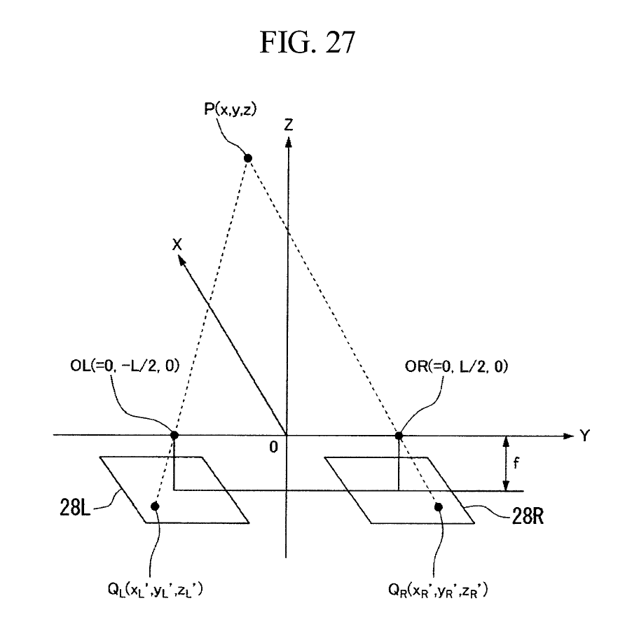

Next, the basic principle of measurement in the present embodiment (i.e., stereo measurement) will be described. FIG. 27 shows the positional relationship between two left and right images on the three-dimensional spatial coordinate system with x, y, and z axes. FIG. 27 shows a state where a point P, which is an object for measuring a distance (object distance) to the subject, is imaged on a right imaging surface 28R and a left imaging surface 28L of the imaging device 28. In FIG. 27, it is assumed that points OR and OL are main points of the optical system, a distance f is a focal length, points Q_{R} and Q_{L} are image locations of the point P, and a distance L is the distance between the point OR and the point OL.

In FIG. 27, expression (1) is obtained from the straight line Q_{R}-OR.

x/x_{R}={y−(L/2)}/{y_{R}−(L/2)}=z/(−f) (1)

In addition, expression (2) is obtained from the straight line Q_{L}-OL.

x/x_{L}={y−(L/2)}/{y_{L}−(L/2)}=z/(−f) (2)

The three-dimensional coordinates of the point P are obtained by solving the expressions for x, y, and z. As a result, the distance (object distance) from the point OR or the point OL to the subject is calculated as the z-coordinate of the point P. In addition, the three-dimensional length and the three-dimensional area can be calculated by calculating the three-dimensional coordinates of the point P for a plurality of measurement points and making various calculations using the three-dimensional coordinates.

Next, operations performed during an inspection will be described. Hereinafter, five operation examples will be given.

### First Operation Example

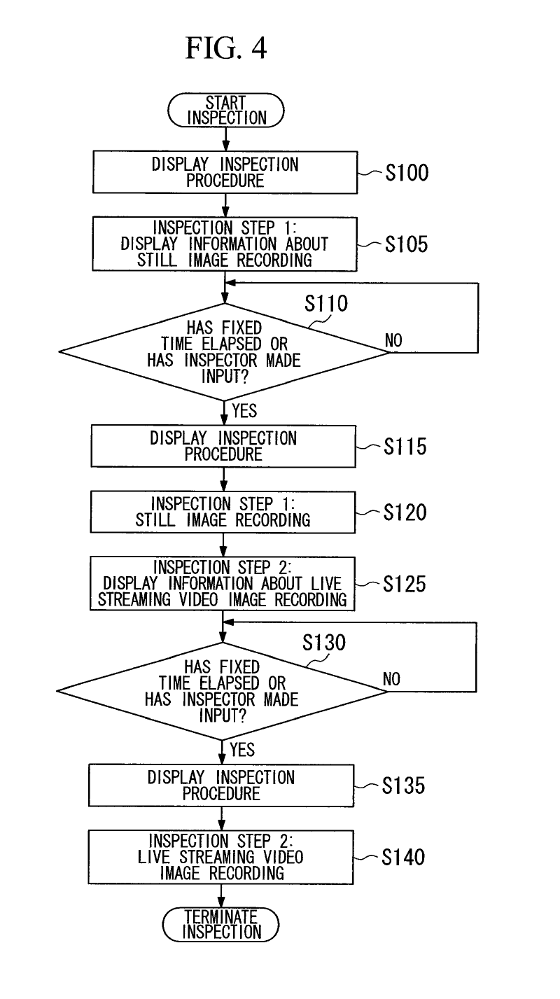

FIG. 4 shows a procedure of a first operation example. When an inspector turns on the power of the endoscope apparatus 1, the operations of each section start, and the monitor 4 displays subject images captured by the imaging device 28. While viewing the image displayed on the monitor 4, the inspector inserts the insertion portion 20 into the interior of the subject to be inspected, and moves the distal end portion 21 to an inspection position. In the example given below, a stereo optical adaptor for stereo measurements is attached to the distal end portion 21.

(Step S100)

When the inspector selects an inspection method and instructs start of the inspection by operating the operation portion 6, the operation detection section 41 detects the start inspection instruction, and notifies the control section 44 of the start inspection instruction. The control section 44 instructs the graphic creation section 43 to create a graphic image signal for displaying an initial inspection procedure. The graphic creation section 43 creates a graphic image signal and outputs it to the video signal processing circuit 12. The video signal processing circuit 12 outputs to the monitor 4 a display signal formed by synthesizing the graphic image signal with the video signal from the CCU 9. Based on this display signal, the monitor 4 displays the subject images captured by the imaging device 28 as well as the inspection procedure. The subject images captured by the imaging device 28 are updated at a constant frequency.

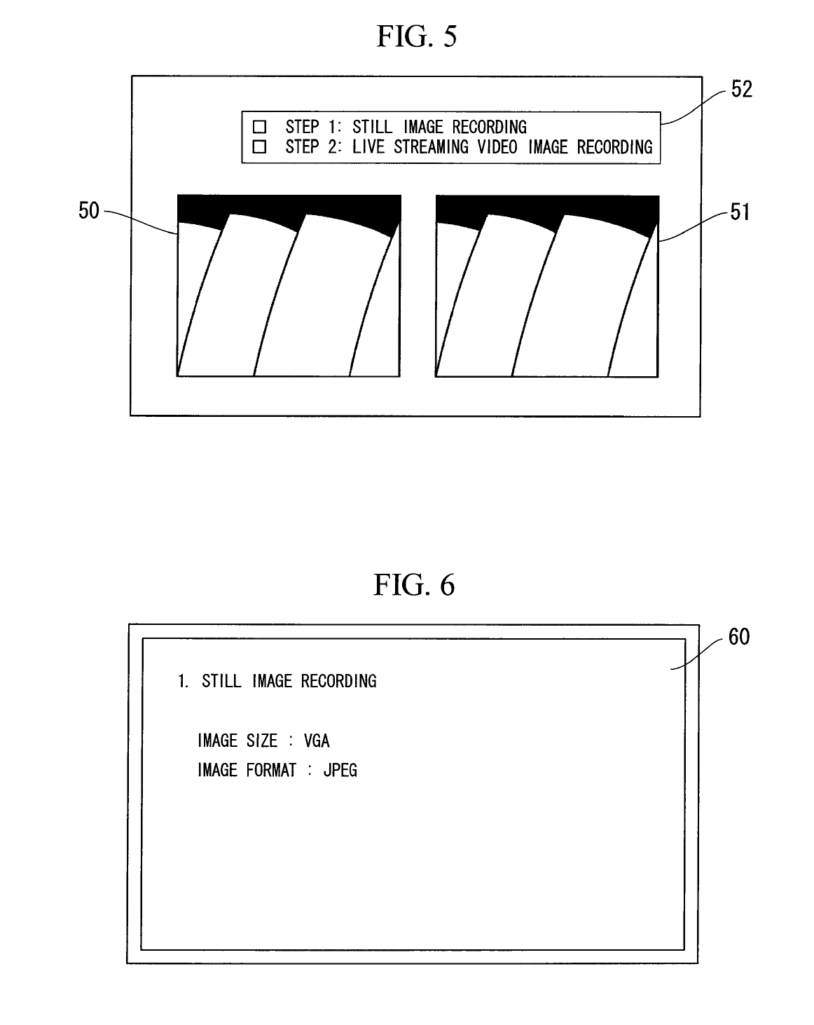

FIG. 5 shows the screen of the monitor 4 when the inspection procedure is displayed. A left image 50 and a right image 51 are left and right subject images captured by the imaging device 28 via the stereo optical adaptor. A region 52 is a region where the inspection procedure is displayed. The inspection procedure of the first operation example includes two inspection steps, namely, still image recording and live streaming video image recording. The still image recording and the live streaming video image recording are inspection steps in which data that is used to subsequently confirm the subject is recorded. When each inspection step is completed, a + sign is displayed in front of the description of that inspection step. The inspector is able to ascertain the state of progress of the inspection by confirming whether or not this + sign is present. In FIG. 5, menus and the like are not shown.

(Step S105)

After the inspection procedure is displayed, the control section 44 instructs the graphic creation section 43 to create a graphic image signal for displaying detailed information about the first inspection step, namely, the still image recording. The graphic creation section 43 creates a graphic image signal and outputs it to the video signal processing circuit 12. The video signal processing circuit 12 outputs the graphic image signal to the monitor 4 as a display signal. Based on this display signal, the monitor 4 displays the detailed information about the still image recording.

FIG. 6 shows the screen of the monitor 4 when the detailed information about the still image recording is displayed thereon. A region 60 is a region where detailed information about each inspection step is displayed. The detailed information about the still image recording includes the image size (for example, 640×480) and the image format (for example, jpg or tiff) of the still image to be recorded. The detailed information about the still image recording shown in FIG. 6 is one example thereof.

In the example shown in FIG. 6, the detailed information about the still image recording is displayed in the region 60 which is larger than the region 52 and is superimposed on the left image 50 and the right image 51, and which occupies almost the entire screen of the monitor 4, or may occupy the entire screen of the monitor 4. Therefore, the fact that the inspection step to be performed next is the still image recording can be made clearly known to the inspector in an easily understood form.

(Step S110)

After the detailed information about the still image recording is displayed, the control section 44 determines whether or not a fixed time has elapsed since the display of the detailed information about the still image recording, and whether or not the operation portion 6 has been operated by the inspector. If the fixed time has not elapsed, and if the operation portion 6 has not been operated by the inspector, the control section 44 repeats the determination step.

(Step S115)

If the fixed time has elapsed, or if the operation portion 6 has been operated by the inspector, the inspection procedure is displayed on the monitor 4 in the same way as in step S100. The screen of the monitor 4 when the inspection procedure is displayed is the same as that shown in FIG. 5.

(Step S120)

After the inspection procedure is displayed, the processing of the first inspection step, namely, of the still image recording is performed. In the still image recording, the inspector operates the operation portion 6 and inputs an instruction to freeze the video image. The operation detection section 41 detects the instruction to freeze the video image and notifies the control section 44 of the instruction to freeze the video image. The video image displayed on the monitor 4 is then frozen by the control of the control section 44. When the inspector operates the operation portion 6 and inputs an instruction to record the still image, the operation detection section 41 detects the instruction to record the still image and notifies the control section 44 of the instruction to record the still image. The control section 44 then records as still image data in the memory card 32 the image data of one frame which has been processed by the video signal processing circuit 12.

(Step S125)

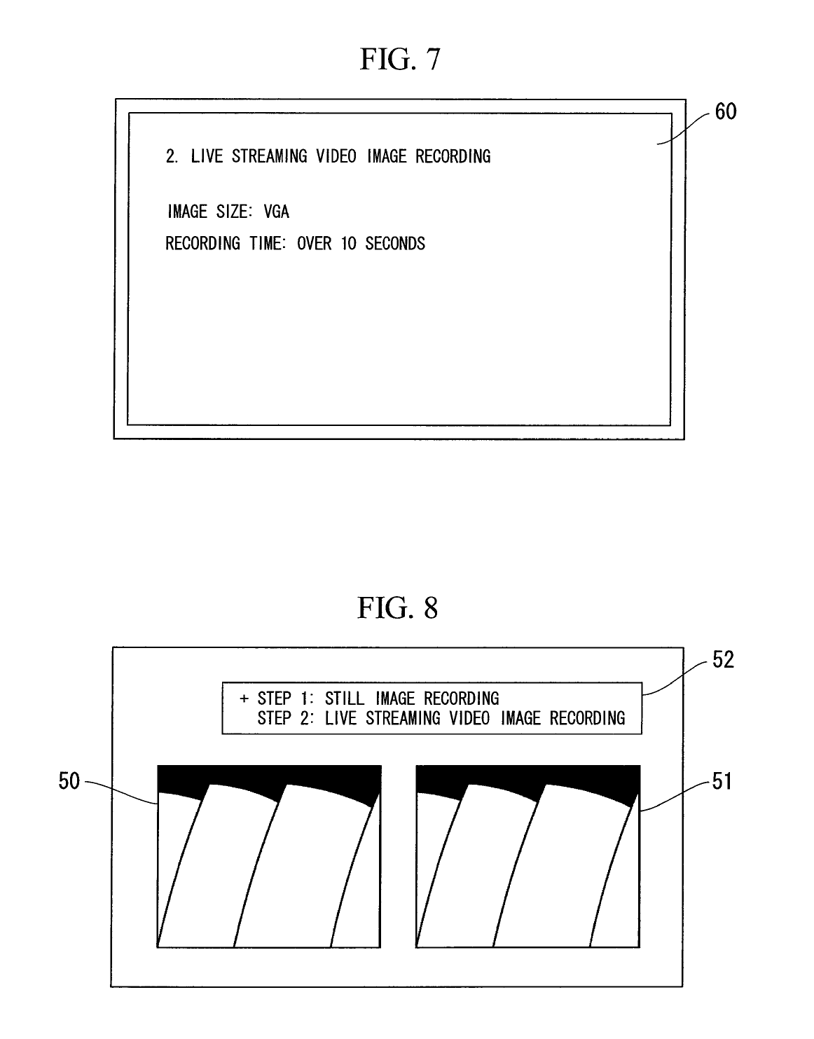

When the still image data has been recorded in the memory card 32, in the same way as in step S105, detailed information about the next inspection step, namely, the live streaming video image recording is displayed. FIG. 7 shows the screen of the monitor 4 when the detailed information about the live streaming video image recording is displayed thereon. The detailed information about the live streaming video image recording is displayed in the region 60. The detailed information about the live streaming video image recording includes the image size currently set and the recording time, which is one of the inspection conditions. The detailed information about the live streaming video image recording shown in FIG. 7 is one example thereof.

(Step S130)

After the detailed information about the live streaming video image recording is displayed, the control section 44 determines whether or not a fixed time has elapsed since the display of the detailed information about the live streaming video image recording, and whether or not the operation portion 6 has been operated by the inspector. If the fixed time has not elapsed, and if the operation portion 6 has not been operated by the inspector, the control section 44 repeats the determination step.

(Step S135)

If the fixed time has elapsed, or if the operation portion 6 has been operated by the inspector, the inspection procedure is displayed on the monitor 4 in the same way as in step S100. At this time, as is shown in FIG. 8, a + sign is displayed in front of the description of the already completed inspection step among the inspection steps contained in the inspection procedure displayed on the monitor 4, namely, in front of the description of the still image recording.

(Step S140)

After the inspection procedure is displayed, the processing of the next inspection step, namely, of the live streaming video image recording is performed. In the live streaming video image recording, the inspector operates the operation portion 6 and inputs an instruction to start the live streaming video image recording. The operation detection section 41 detects the instruction to start the live streaming video image recording and notifies the control section 44 of the instruction to start the live streaming video image recording. The control section 44 then records as live streaming video image data in the memory card 32 the image data of each frame which has been processed by the video signal processing circuit 12. Next, the inspector operates the operation portion 6 and inputs an instruction to terminate the live streaming video image recording. The operation detection section 41 detects the instruction to terminate the live streaming video image recording and notifies the control section 44 of the instruction to terminate the live streaming video image recording. The control section 44 then terminates the live streaming video image recording. When the live streaming video image recording terminates, the inspection also terminates.

As is described above, since information that includes the inspection conditions of the relevant inspection step is displayed immediately prior to each inspection step of an inspection procedure which includes still image recording and live streaming video image recording, it is possible to make information about each inspection step to be performed known to the inspector in an easily understood form.

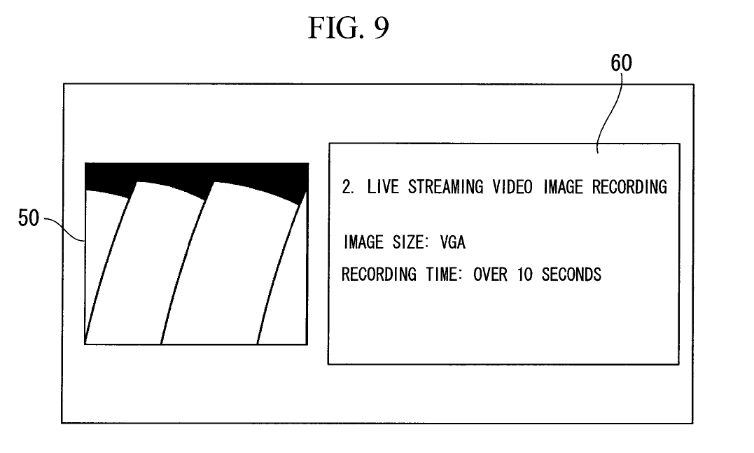

Variations such as those described below may be displayed on the screen of the monitor 4 shown in FIG. 6 and FIG. 7. Since one of the aims is to enable the inspector to recognize which inspection step is to be performed next, only the name of each inspection step may be displayed without displaying detailed information about that inspection step. In addition or alternatively, in FIG. 6 and FIG. 7, the region 60 where information about each inspection step is displayed occupies almost the entire screen of the monitor 4, and an image of the subject to be inspected is not displayed, however, as is shown in FIG. 9, the region 60 may be displayed together with an image of the subject to be inspected.

Moreover, the apparatus may be configured so as to enable an inspector to alter the inspection conditions and the settings when detailed information about an inspection step is displayed. For example, in the region 60 shown in FIG. 7, a GUI (graphical user interface) which can be operated by the inspector may be prepared so that the inspector can alter the image size by operating the GUI via the operation portion 6.

Moreover, the inspection procedure may be displayed in the following manner. In the above description, completed inspection steps are distinguished from uncompleted inspection steps by the presence or absence of a + sign, however, this distinction may be made by means of a different method. For example, such distinctions may be made by means of differences in the color of the characters, differences in the size of the characters, differences in the character font, differences in the background color of the characters, or the presence or absence of a mark.

Moreover, in each of the above described inspection steps, control of prohibiting operations of other inspection steps may be performed until an operation which is assumed as an operation of that inspection step has completed. For example, in the still image recording, operations such as measurement and live streaming video image recording may be prohibited until an instruction to record the still image has been input. Alternatively, in the live streaming video image recording, operations such as still image recording and measurement may be prohibited until an instruction to terminate the live streaming video image recording has been input.

The above described alterations are not limited to the first operation example and may also be performed in other operation examples, including the operation examples described below.

### Second Operation Example

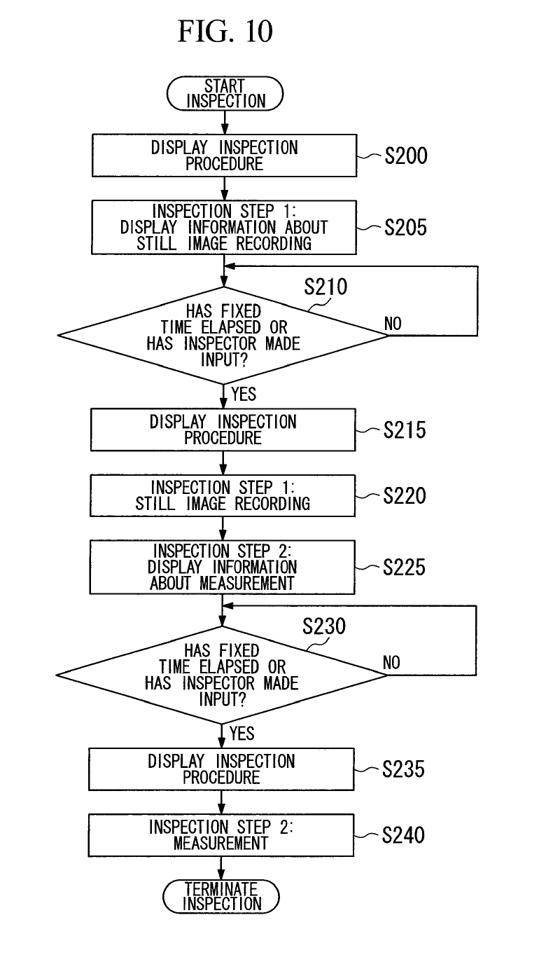

FIG. 10 shows the procedure of a second operation example. In the description given below, any description of the processing of an inspection step which is the same as in the first operation example is omitted.

(Steps S200 Through S220)

The processing of steps S200 through S220 is the same as the processing of steps S100 through S120 of FIG. 4. The inspection procedure in the second operation example includes two inspection steps, namely, still image recording and measurement. The measurement is an inspection step to measure the size of the subject.

(Step S225)

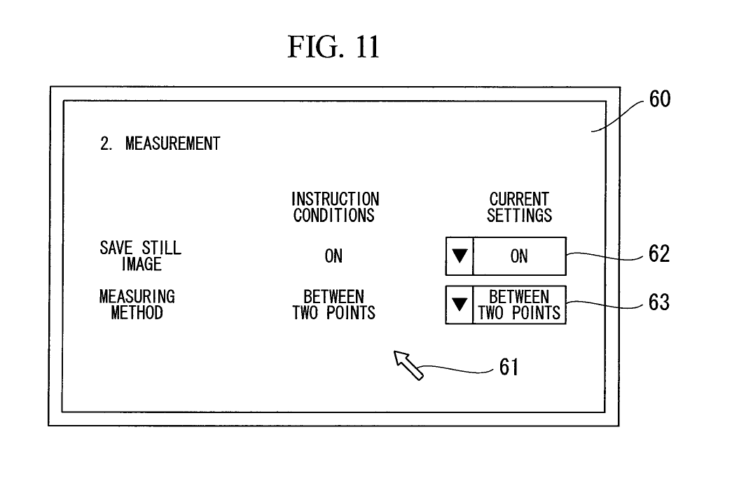

When the still image data has been recorded in the memory card 32, in the same way as in step S205, detailed information about the next inspection step, namely, about the measurement is displayed. FIG. 11 shows the screen of the monitor 4 when the detailed information about the measurement is displayed. The detailed information about the measurement is displayed in the region 60. The detailed information about the measurement includes the conditions and the current settings that are set as inspection conditions for deciding whether or not a still image is saved, and includes the conditions and the current settings that are set as inspection conditions for a measuring method. The detailed information about the measurement shown in FIG. 11 is one example thereof.

The inspector is able to alter the current settings by operating the operation portion 6 to move the cursor 61 and operate the GUI 62 and 63 provided in the region 60 by means of the cursor 61. For example, if the inspector operates the GUI 63, the operation detection section 41 detects the operation of the GUI 63, and notifies the control section 44 that the GUI 63 has been operated. The control section 44 controls the graphic creation section 43 in accordance with the operation of the GUI 63 to control the display contents in the region 60, and also sets the measuring method. As a result, a plurality of measuring methods which can be selected are displayed. When the inspector selects the desired measuring method using the cursor 61, the selected measuring method is set.

(Step S230)

After the detailed information about the measurement has been displayed, the control section 44 determines whether or not a fixed time has elapsed since the display of the detailed information about the measurement, and whether or not the operation portion 6 has been operated by the inspector. If the fixed time has not elapsed, and if the operation portion 6 has not been operated by the inspector, the control section 44 repeats the determination step.

(Step S235)

If the fixed time has elapsed, or if the operation portion 6 has been operated by the inspector, the inspection procedure is displayed on the monitor 4 in the same way as in step S200. At this time, a + sign is displayed in front of the description of the already completed inspection step among the inspection steps contained in the inspection procedure displayed on the monitor 4, namely, in front of the description of the still image recording.

(Step S240)

After the inspection procedure is displayed, the processing of the next inspection step, namely, of the measurement is performed. In the measurement, the image data of one frame which has been processed by the video signal processing circuit 12 is used. The inspector operates the operation portion 6 and inputs a measuring point which shows the measurement position on the left image displayed on the monitor 4. For example, in point-to-point measurement, two measurement points are input. The positions of the measurement points are specified using the cursor displayed on the monitor 4.

The operation detection section 41 detects the type of operation of the operation portion 6. The calculation section 42 calculates two-dimensional coordinates (i.e., image coordinates) of the measurement point based on the type of operation, and also calculates the two-dimensional coordinates of a point on the right image that corresponds to the calculated two-dimensional coordinates of the measurement point by pattern matching of the left and right images. The calculation section 42 calculates spatial three-dimensional coordinates from the two-dimensional coordinates of the measurement point on the left image and the point on the right image that corresponds to the measurement point. The calculation section 42 then calculates the size of the subject to be inspected from the three-dimensional coordinates of a plurality of points. The calculated size of the subject to be inspected is displayed on the monitor 4 as a measurement result. When the measurement result is displayed, the inspection is terminated.

As is described above, since information that includes the inspection conditions of the relevant inspection step is displayed immediately prior to each inspection step of an inspection procedure which includes still image recording and measurement, it is possible to make information about each inspection step to be performed known to the inspector in an easily understood form.

In each of the above described inspection steps, control of prohibiting operations of other inspection steps may be performed until an operation which is assumed as an operation of that inspection step has completed. For example, in the measurement, operations such as still image recording and live streaming video image recording may be prohibited until the necessary number of measurement points required for the measurement has been input.

### Third Operation Example

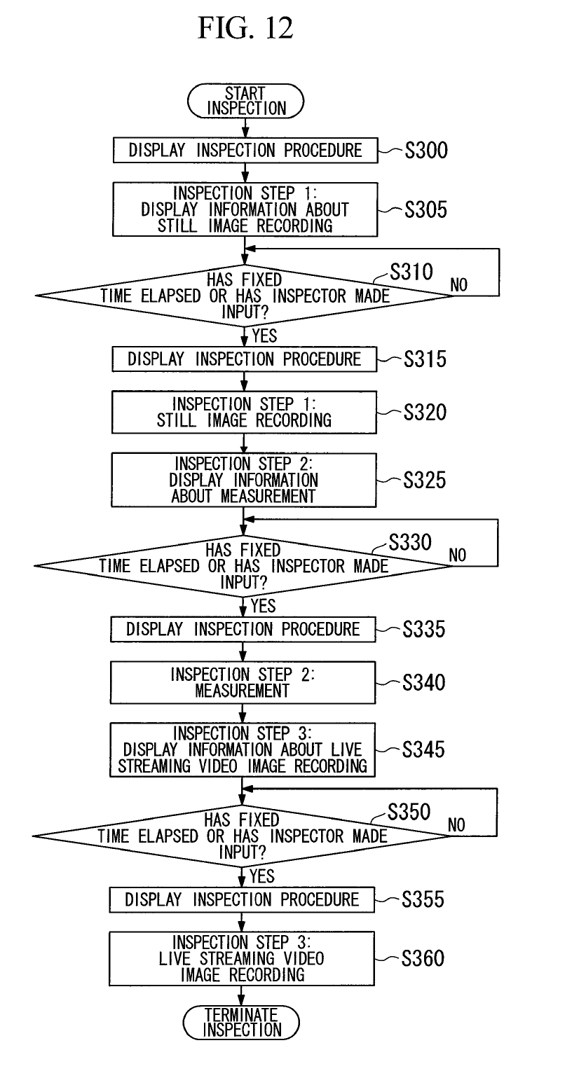

FIG. 12 shows the procedure of a third operation example. In the description given below, any description of the processing of an inspection step which is the same as in the first operation example or the second operation example is omitted.

(Step S300)

In step S300, the inspection procedure is displayed on the monitor 4. The inspection procedure in the third operation example includes three inspection steps, namely, still image recording, measurement, and live streaming video image recording.

(Step S305)

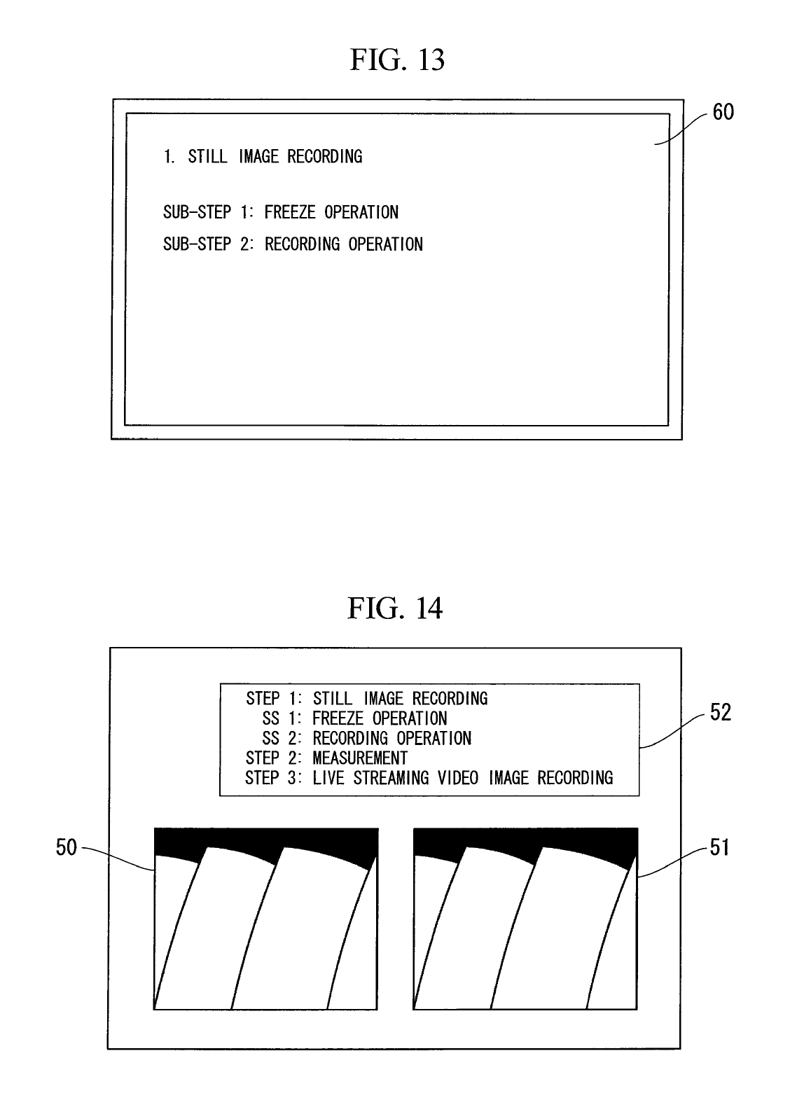

In step S305, detailed information about the next inspection step, namely, about the still image recording is displayed. FIG. 13 shows the screen of the monitor 4 when the detailed information about the still image recording is displayed. Information about the necessary operation steps (i.e., sub-steps) required for performing the still image recording is displayed in the region 60 as the detailed information about the still image recording. The sub-steps of the still image recording include a freeze operation to freeze the video image displayed on the monitor 4, and a recording operation to record the frozen still image. Since the detailed information about the still image recording such as that shown in FIG. 13 is displayed, the inspector is able to ascertain the operations to be implemented in the still image recording as well as the sequence thereof. The detailed information about the still image recording shown in FIG. 13 is one example thereof.

(Step S310)

After the detailed information about the still image recording is displayed, the control section 44 determines whether or not a fixed time has elapsed since the display of the detailed information about the still image recording, and whether or not the operation portion 6 has been operated by the inspector. If the fixed time has not elapsed, and if the operation portion 6 has not been operated by the inspector, the control section 44 repeats the determination step.

(Step S315)

If the fixed time has elapsed, or if the operation portion 6 has been operated by the inspector, the inspection procedure is displayed on the monitor 4 in the same way as in step S300. At this time, as is shown in FIG. 14, the sub-step procedure for the first inspection step, namely, for the still image recording is also displayed.

(Step S320)

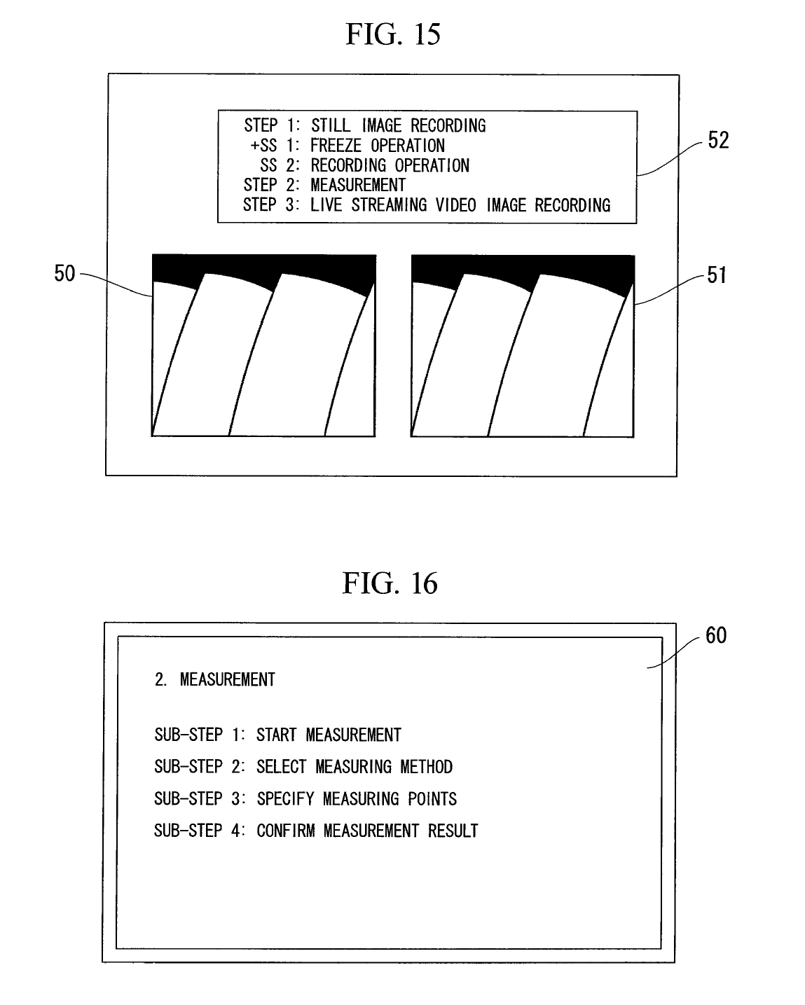

After the inspection procedure is displayed, the processing of the first inspection step, namely, of the still image recording is performed. The processing of the still image recording is the same as the processing of step S120 shown in FIG. 4. In the processing of the still image recording, when the inspector inputs an instruction to freeze the video image, as is shown in FIG. 15, a + sign is displayed in front of the description of the first sub-step in the inspection procedure displayed on the monitor 4.

(Step S325)

When the still image data has been recorded in the memory card 32, in the same way as in step S305, the detailed information about the next inspection step, namely, about the measurement is displayed. FIG. 16 shows the screen of the monitor 4 when the detailed information about the measurement is displayed thereon. Information about the necessary operation steps (i.e., sub-steps) required for performing the measurement is displayed in the region 60 as the detailed information about the measurement. The sub-steps of the measurement include starting measurement, selecting a measuring method, specifying measurement points, and confirming a measurement result. The detailed information about the measurement shown in FIG. 16 is one example thereof.

(Step S330)

After the detailed information about the measurement is displayed, the control section 44 determines whether or not a fixed time has elapsed since the display of the detailed information about the measurement, and whether or not the operation portion 6 has been operated by the inspector. If the fixed time has not elapsed, and if the operation portion 6 has not been operated by the inspector, the control section 44 repeats the determination step.

(Step S335)

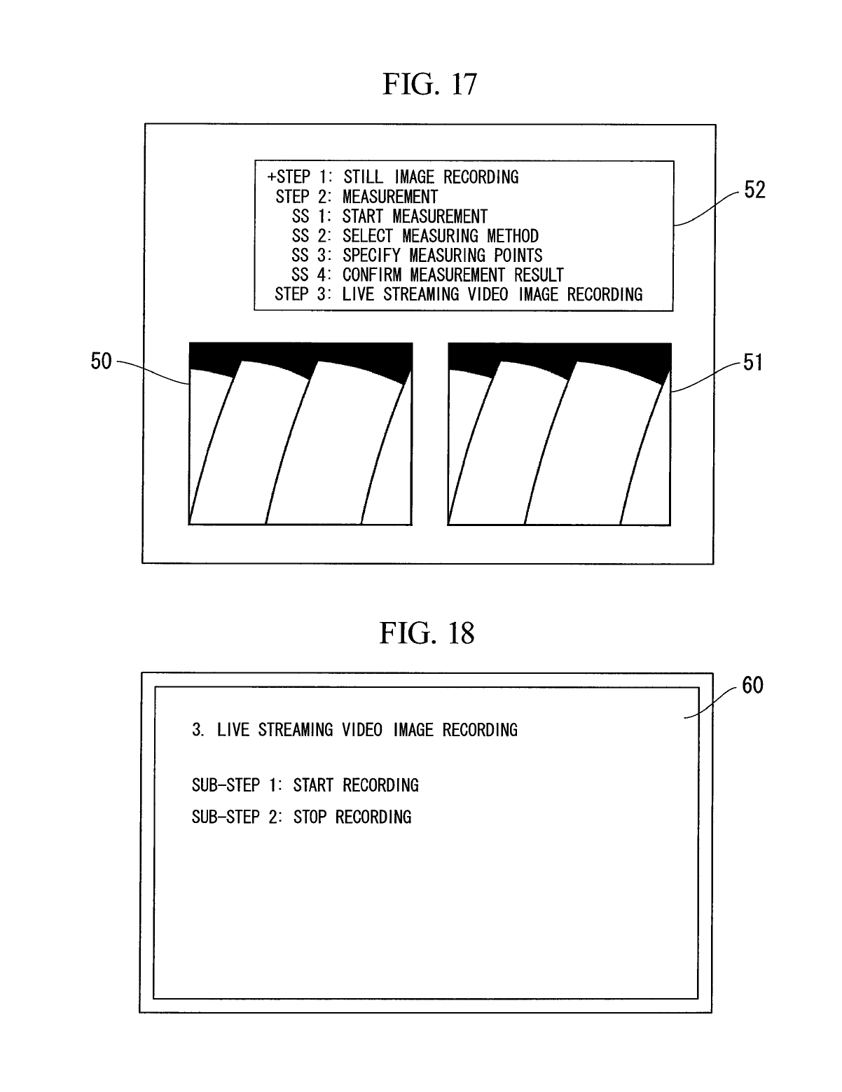

If the fixed time has elapsed, or if the operation portion 6 has been operated by the inspector, the inspection procedure is displayed on the monitor 4 in the same way as in step S300. At this time, as is shown in FIG. 17, a + sign is displayed in front of the description of the already completed inspection step among the inspection steps contained in the inspection procedure displayed on the monitor 4, namely, in front of the description of the still image recording, and the sub-step procedure for the next inspection step, namely, for the measurement is also displayed.

(Step S340)

After the inspection procedure is displayed, the processing of the next inspection step, namely, of the measurement is performed. The processing of the measurement is the same as the processing of step S240 shown in FIG. 10. In the processing of the measurement, when the inspector inputs an instruction to start measurement, a + sign is displayed in front of the description of the first sub-step of the inspection procedure which is displayed on the monitor 4. Next, when the inspector inputs an instruction to select the measuring method, a + sign is displayed in front of the description of the next sub-step of the inspection procedure which is displayed on the monitor 4. Next, when the inspector inputs an instruction to specify a measurement point and all of the measurement points required for the measurement have been specified, a + sign is displayed in front of the description of the next sub-step of the inspection procedure which is displayed on the monitor 4.

(Step S345)

When the measurement result is displayed on the monitor 4, and the inspector has performed an operation to indicate that the measurement result has been confirmed, the detailed information about the next inspection step, namely, about the live streaming video image recording is displayed in the same way as in step S305. FIG. 18 shows the screen of the monitor 4 when the detailed information about the live streaming video image recording is displayed thereon. Information about the necessary operation steps (i.e., sub-steps) required for performing the live streaming video image recording is displayed in the region 60 as the detailed information about the live streaming video image recording. The sub-steps of the live streaming video image recording include starting recording and stopping recording. The detailed information about the live streaming video image recording shown in FIG. 18 is one example thereof.

(Step S350)

After the detailed information about the live streaming video image recording is displayed, the control section 44 determines whether or not a fixed time has elapsed since the display of the detailed information about the live streaming video image recording, and whether or not the operation portion 6 has been operated by the inspector. If the fixed time has not elapsed, and if the operation portion 6 has not been operated by the inspector, the control section 44 repeats the determination step.

(Step S355)

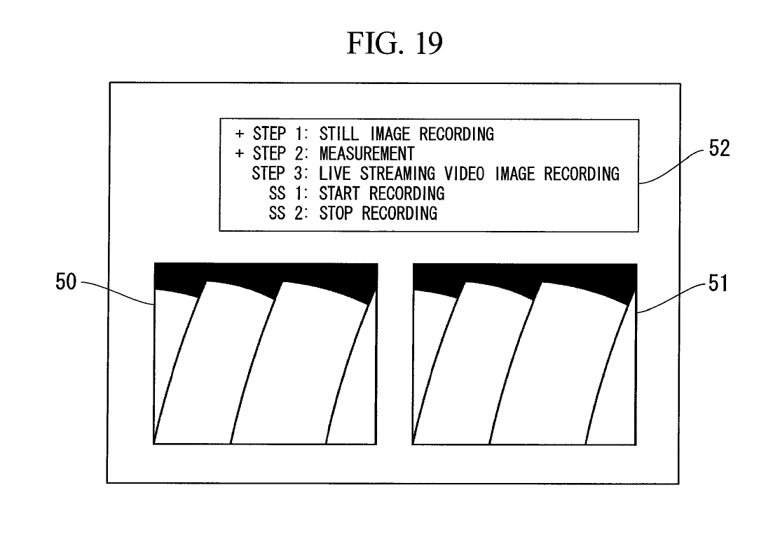

If the fixed time has elapsed, or if the operation portion 6 has been operated by the inspector, the inspection procedure is displayed on the monitor 4 in the same way as in step S300. At this time, as is shown in FIG. 19, a + sign is displayed in front of the descriptions of the already completed inspection steps among the inspection steps contained in the inspection procedure displayed on the monitor 4, namely, in front of the descriptions of the still image recording and the measurement, and the sub-step procedure for the next inspection step, namely, for the live streaming video image recording is also displayed.

(Step S360)

After the inspection procedure is displayed, the processing of the next inspection step, namely, of the live streaming video image recording is performed. The processing of the live streaming video image recording is the same as the processing of step S140 shown in FIG. 4. In the processing of the live streaming video image recording, when the inspector inputs an instruction to start the live streaming video image recording, a + sign is displayed in front of the description of the first sub-step of the inspection procedure which is displayed on the monitor 4. Next, when the inspector inputs an instruction to terminate the live streaming video image recording, the live streaming video image recording is terminated.

As is described above, since information that includes the operating procedure of the relevant inspection step is displayed immediately prior to each inspection step of an inspection procedure which includes still image recording, measurement, and live streaming video image recording, it is possible to make information about each inspection step to be implemented known to the inspector in an easily understood form.

### Fourth Operation Example

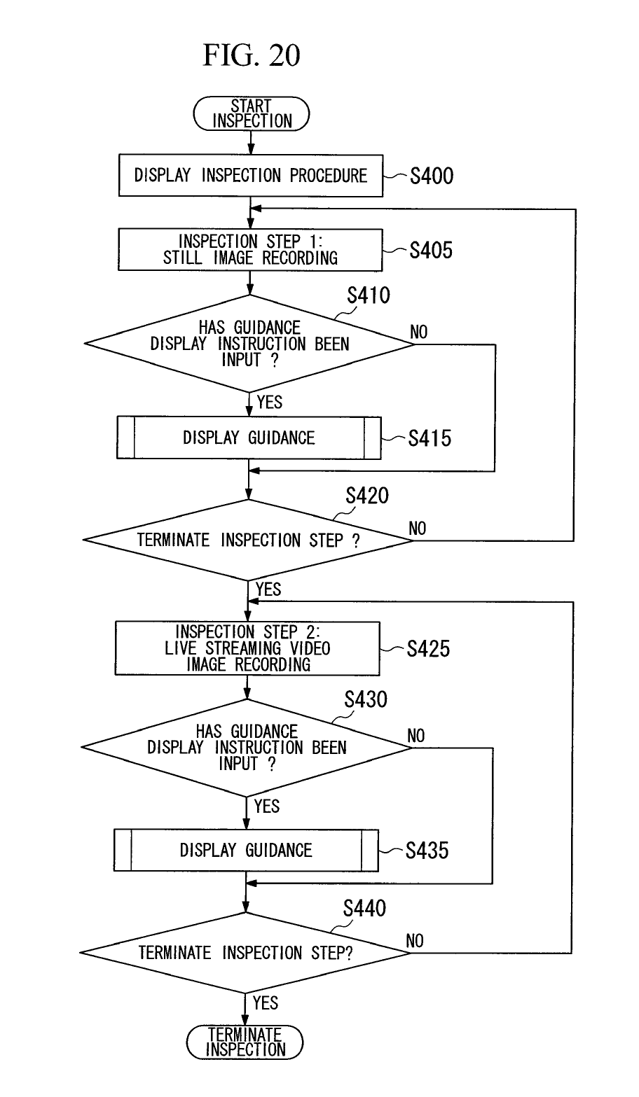

In the first through third operation examples, immediately prior to each inspection step of an inspection procedure, information about that step is displayed. However, in a fourth operation example, while each inspection step of an inspection procedure is being implemented, guidance information showing the procedure of sub-steps included in that inspection step is displayed. FIG. 20 shows the procedure of the fourth operation example. In the description given below, any description of the processing of an inspection step which is the same as in the first through third operation examples is omitted.

(Step S400)

In step S400, the inspection procedure is displayed on the monitor 4. The inspection procedure in the fourth operation example includes two inspection steps, namely, still image recording and live streaming video image recording.

(Step S405)

After the inspection procedure is displayed, the processing of the first inspection step, namely, of the still image recording is performed. The processing of the still image recording is the same as the processing of step S120 shown in FIG. 4. In the fourth operation example, the processing of the still image recording is begun at step S405, and then the processing moves to step S410.

(Step S410)

The control section 44 determines whether or not the inspector has operated the operation portion 6 and input an instruction to display guidance. For example, the inspector inputs the guidance display instruction when the inspector desires to know detailed information about the inspection step currently being implemented.

(Step S415)

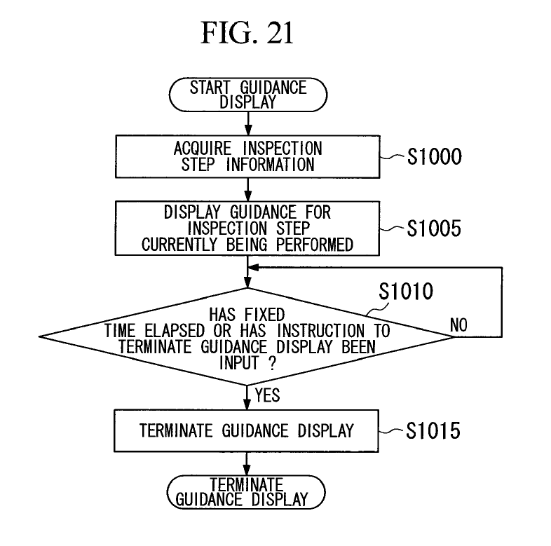

If the guidance display instruction has been input, guidance display processing is performed. FIG. 21 shows details of the guidance display processing.

(Step S1000)

The control section 44 acquires information about the inspection step currently being implemented. For example, a flag is prepared in the RAM 14 for each inspection step, and the control section 44 refers to the information of the flags and thereby acquires information about the inspection step currently being implemented.

(Step S1005)

After acquiring the inspection step information, the control section 44 instructs the graphic creation section 43 to create a graphic image signal for displaying the guidance for that inspection step. The graphic creation section 43 creates a graphic image signal and then outputs it to the video signal processing circuit 12. The video signal processing circuit 12 outputs the graphic image signal to the monitor 4 as a display signal. The monitor 4 displays the guidance for the inspection step currently being implemented based on this display signal.

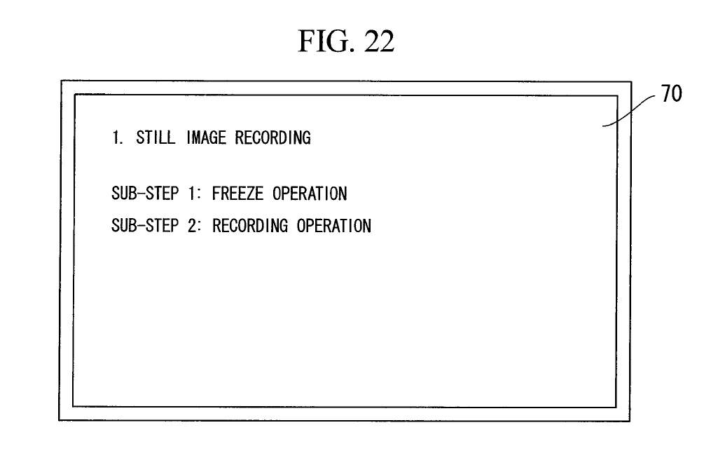

FIG. 22 shows the screen of the monitor 4 when the guidance is displayed while still image recording is being implemented. A region 70 is a region where the guidance for each inspection step is displayed. In the fourth operation example, the procedure of the sub-steps included in each inspection step is displayed as guidance. By displaying the detailed information about the still image recording such as that shown in FIG. 22, the inspector is able to ascertain the operations to be implemented for the still image recording as well as the sequence thereof.

(Step S1010)

After the guidance for the inspection step currently being implemented is displayed, the control section 44 determines whether or not a fixed time has elapsed since the display of the guidance, and whether or not the inspector has operated the operation portion 6 and input an instruction to terminate the guidance display. If the fixed time has not elapsed, and an instruction to terminate the guidance display has not been input, the control section 44 repeats the determination step.

(Step S1015)

If the fixed time has elapsed, or if an instruction to terminate the guidance display has been input, the guidance changes to non-display and the inspection procedure is displayed on the monitor 4. The guidance display is then terminated.

(Step S420)

After the guidance is displayed in step S415, or if an instruction to display the guidance has not been input in step S410, the control section 44 determines whether or not to terminate the processing of the inspection step currently being implemented. In the still image recording, the condition used to make this determination is whether or not still image data has been recorded in the memory card 32. If the still image data has not been recorded in the memory card 32, the processing of step S405 is performed once again.

(Step S425)

If the still image data has been recorded in the memory card 32, a + sign is displayed in front of the description of the already completed inspection step among the inspection steps contained in the inspection procedure displayed on the monitor 4, namely, in front of the description of the still image recording, and the processing of the next inspection step, namely, of the live streaming video image recording is performed. The processing of the live streaming video image recording is the same as the processing of step S140 shown in FIG. 4. In the fourth operation example, the processing of the live streaming video image recording is begun at step S425, and then the processing moves to step S430.

(Step S430)

The control section 44 determines whether or not the inspector has operated the operation portion 6 and input an instruction to display the guidance.

(Step S435)

If an instruction to display the guidance has been input, guidance display processing is performed. The guidance display processing is the same as the processing of step S415.

(Step S440)

After the guidance is displayed in step S435, or if an instruction to display guidance has not been input in step S430, the control section 44 determines whether or not to terminate the processing of the inspection step currently being implemented. In the live streaming video image recording, the condition used to make this determination is whether or not an instruction to terminate the live streaming video image recording has been input. If an instruction to terminate the live streaming video image recording has not been input, the processing of step S425 is performed once again. If an instruction to terminate the live streaming video image recording has been input, the inspection is terminated.

As is described above, since information that includes the operating procedure of the relevant inspection step is displayed at the request of the inspector while an inspection step (or each inspection step) of an inspection procedure which includes the still image recording and the live streaming video image recording is being implemented, it is possible to make information about each inspection step to be performed known to the inspector in an easily understood form.

In FIG. 22, the region 70 where the guidance for the inspection steps is displayed occupies almost the entire screen of the monitor 4, or may occupy the entire screen of the monitor 4, and the image of the subject to be inspected is not displayed, however, the region 70 may be displayed together with the image of the subject to be inspected, for example in the same way that the region 60 is displayed together with the image in the example of the screen shown in FIG. 9.

When the sub-steps of each inspection step are displayed together with the inspection procedure, a + sign may be displayed in front of the description of the already completed sub-steps.

The guidance may be displayed if a fixed time has passed since the inspection step is started and if no operation has been performed during this fixed time. Accordingly, after displaying the inspection procedure and starting the processing of the inspection step, if the length of time during which no instruction has been input by the inspector reaches a predetermined time, the control section 44 performs control to display the guidance.

The guidance may be displayed when an inspection step is started and an operation which is different from the operation which is expected as an operation of that inspection step is performed. Accordingly, after displaying the inspection procedure and starting the processing of the inspection step, if an instruction which is different from the instruction expected for that inspection step is input by the inspector, the control section 44 performs control to display the guidance. For example, the guidance is displayed when an instruction for the live streaming video image recording is input during the still image recording.

### Fifth Operation Example

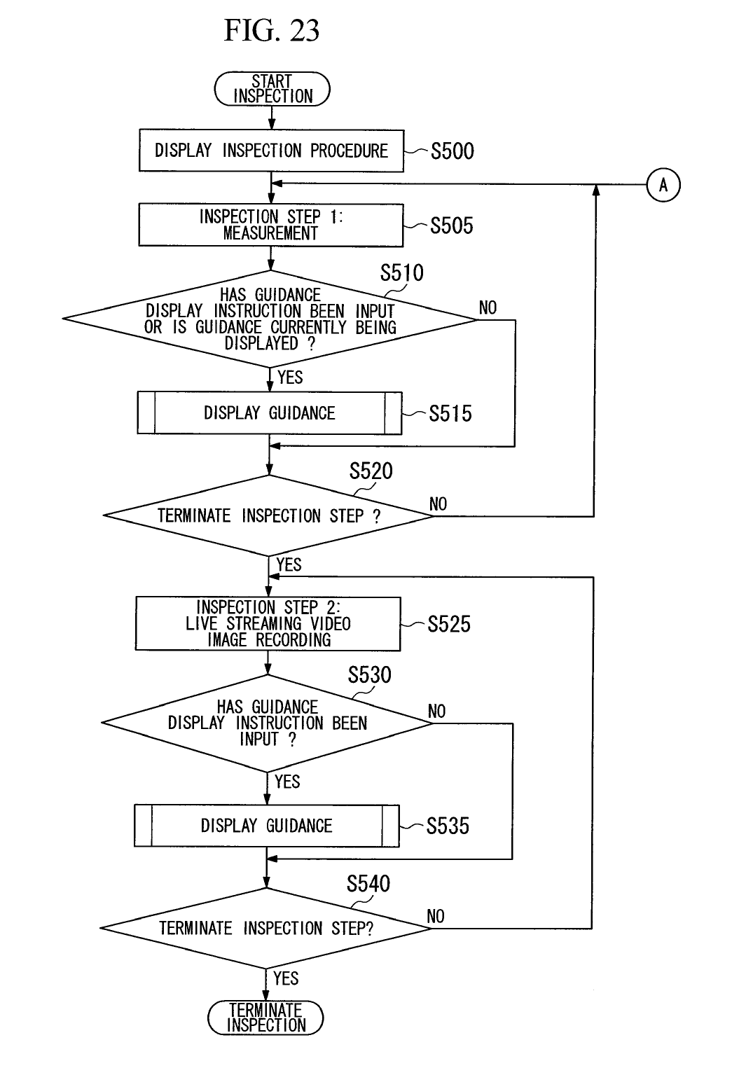

FIG. 23 shows the procedure of a fifth operation example. In the description given below, any description of the processing of an inspection step which is the same as in the first through fourth operation examples is omitted.

(Step S500)

In step S500, the inspection procedure is displayed on the monitor 4. The inspection procedure in the fifth operation example includes two inspection steps, namely, measurement and live streaming video image recording.

(Step S505)

After the inspection procedure is displayed, the processing of the first inspection step, namely, of the measurement is performed. The processing of the measurement is the same as the processing of step S240 shown in FIG. 10. In the fifth operation example, the processing of the measurement is begun at step S505, and then the processing moves to step S510.

(Step S510)

The control section 44 determines whether or not the inspector has operated the operation portion 6 and input an instruction to display guidance, and also determines whether or not the current state is one in which guidance is being displayed.

(Step S515)

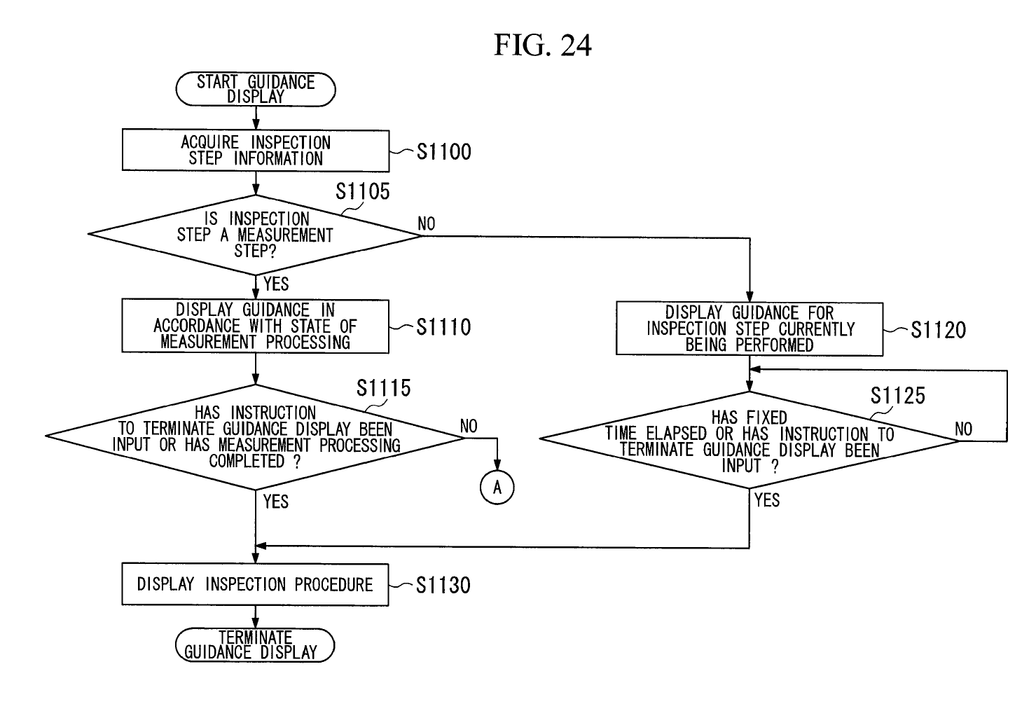

If a guidance display instruction has been input, or if the current state is a guidance display state, guidance display processing is performed. FIG. 24 shows details of the guidance display processing.

(Step S1100)

The control section 44 acquires information about the inspection step currently being implemented.

(Step S1105)

After acquiring the inspection step information, the control section 44 determines whether or not the inspection step currently being implemented is the measurement step. If the inspection step currently being implemented is not the measurement step, the processing of steps S1120 through S1130 is performed. This processing is the same as the processing of steps S1005 through S1015 shown in FIG. 21.

(Step S1110)

If the inspection step currently being implemented is the measuring step, the guidance is displayed in accordance with the state of the measuring processing. The state of the measuring processing includes the display position of the cursor, the display position of the measurement points and the like. If the cursor and the measurement points are obscured by the guidance, the operations required for the measurement are hindered. Consequently, in this example, based on the display positions of the cursor and the measurement points, the control section 44 controls the display position of the guidance such that the cursor and measurement positions are not obscured by the guidance.

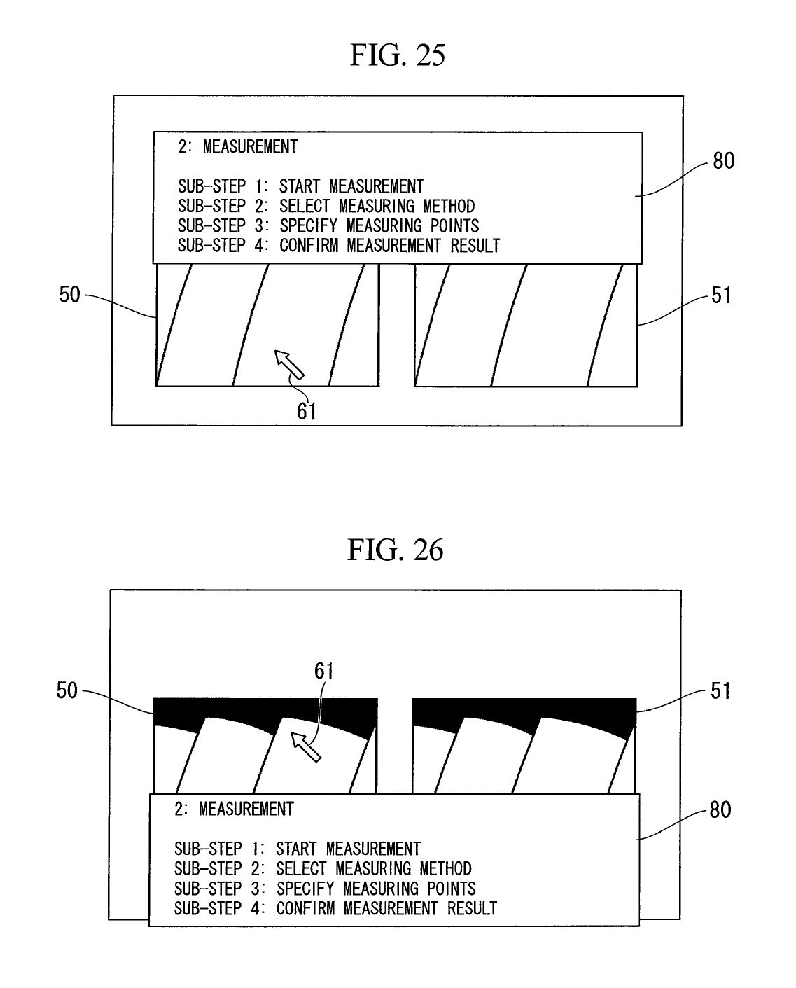

For example, as is shown in FIG. 25, when the cursor 61 is in the bottom portion of the screen of the monitor 4, a region 80 where the guidance is displayed is in the top portion of the screen. When the inspector operates the operation portion 6 and moves the cursor 61 to the top portion, if the cursor 61 reaches a position where it is superimposed on the region 80, as is shown in FIG. 26, the region 80 moves to the bottom portion of the screen.

(Step S1115)

After controlling the display position of the guidance, the control section 44 determines whether or not the inspector has operated the operation portion 6 and input an instruction to terminate the guidance display, and also determines whether or not the measuring processing has completed. The condition used to make this determination of whether or not the measuring processing has completed is whether or not the inspector has performed an operation to indicate that the measurement result has been confirmed after the measurement result is displayed. If an instruction to terminate the guidance display has not been input, and if measuring processing has not completed, the processing moves to step S505.

(Step S1130)

If an instruction to terminate a guidance display has been input, or if measuring processing has completed, then the guidance changes to non-display and the inspection procedure is displayed on the monitor 4. The guidance display is then terminated.

(Step S520)

After the guidance is displayed in step S515, or if an instruction to display the guidance has not been input in step S510, or if the current state is a guidance display state in step S510, the control section 44 determines whether or not to terminate the processing of the inspection step currently being implemented. The condition used to make this determination is whether or not the inspector has performed an operation to indicate that the measurement result has been confirmed after the measurement result is displayed. If the operation to show that the measurement result has been confirmed has not been performed, the processing of step S505 is performed once again.

(Steps S525 Through S540)

The processing of steps S525 through S540 which is performed after the measurement is the same as the processing of steps S425 through S440 shown in FIG. 20. However, the processing of step S535 is the same as the processing shown in FIG. 24.

As is described above, since information that includes the operating procedure of the relevant inspection step is displayed at the request of the inspector while an inspection step (or each inspection step) of an inspection procedure which includes the measurement and the live streaming video image recording is being implemented, it is possible to make information about each inspection step to be performed known to the inspector in an easily understood form.

In the above description, in the measurement, the guidance display position is controlled such that it does not obstruct the measurement operation, however, the size of the guidance may be controlled in addition to or instead of the display position. Alternatively, without altering the guidance display position, the guidance may be made transparent such that the cursor and measurement points as well as the guidance are visible.

In each of the above described operation examples, various modifications in addition to those described above are also possible. For example, stereo measurement is used in the measurement inspection step, however, any type of measurement may be used as long as the measurement utilizes an image of the subject. Moreover, left and right subject images obtained via a stereo optical adaptor having two observation fields of view are displayed on the monitor 4, however, a subject image obtained via a normal observation optical adaptor having one observation field of view may be displayed on the monitor 4.

As has been described above, according to the present embodiment, it is possible to switch between a display mode in which an inspection procedure which includes a plurality of inspection steps and an image of a subject to be inspected are displayed, and a display mode in which information relating to the inspection steps is displayed. Therefore, it is possible to make information about each inspection step to be performed known to an inspector in an easily understood form.

Moreover, when an inspection procedure is displayed, by displaying inspection steps which have already been completed as distinct from uncompleted inspection steps, an inspector is able to ascertain the state of progress of an inspection.

Moreover, when an altered inspection procedure is displayed, by displaying added inspection steps as distinct from the inspection steps included in the original inspection procedure, an inspector is able to easily ascertain the added inspection steps.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as limited by the foregoing description and is only limited by the scope of the appended claims.

What is claimed is:

1. An inspection apparatus comprising:
a display;
a display control section which displays, on a first surface area of the display, instructions for carrying out a plurality of inspection steps with the inspection apparatus, and which displays, on a second surface area of the display that is greater than the first surface area, instructions for carrying one of the inspection steps; and
a controller which controls the display control section to display instructions for carrying a first one of the inspection steps on the second surface area before the first one of the inspection steps is performed, and to display instructions for carrying a second one of the inspection steps on the second surface area after the first one of the inspection steps is performed and before the second one of the inspection steps is performed.

2. The apparatus according to claim 1, wherein the second surface area of the display is an entire surface area of the display.

3. A method for an inspection apparatus including a display, the method comprising:
displaying, on a first area of the display, instructions for carrying out a plurality of inspection steps with the inspection apparatus, before the inspection steps are carried out;
displaying, on a second area of the display that is larger than the first area, instructions for carrying out a first one of the inspection steps, before the first inspection step is carried out; and
displaying, on the second area of the display, instructions for carrying out a second one of the inspection steps, after the first inspection step is carried out and before the second inspection step is carried out.

4. The method according to claim 3, wherein the second surface area of the display is an entire surface area of the display.

5. An inspection apparatus comprising:
a display;
display control means for displaying, on a first surface area of the display, instructions for carrying out a plurality of inspection steps with the inspection apparatus, and for displaying, on a second surface area of the display that is greater than the first surface area, instructions for carrying one of the inspection steps; and
control means for controlling the display control means to display instructions for carrying a first one of the inspection steps on the second surface area before the first one of the inspection steps is performed, and to display instructions for carrying a second one of the inspection steps on the second surface area after the first one of the inspection steps is performed and before the second one of the inspection steps is performed.

6. The apparatus according to claim 5, wherein the second surface area of the display is an entire surface area of the display.

7. A non-transitory computer readable recording medium having a computer program stored thereon that is executable by a computer of an inspection apparatus including a display, to control the inspection apparatus to perform functions comprising:
displaying, on a first area of the display, instructions for carrying out a plurality of inspection steps with the inspection apparatus, before the inspection steps are carried out;
displaying, on a second area of the display that is larger than the first area, instructions for carrying out a first one of the inspection steps, before the first inspection step is carried out; and
displaying, on the second area of the display, instructions for carrying out a second one of the inspection steps, after the first inspection step is carried out and before the second inspection step is carried out.

8. The non-transitory computer readable recording medium according to claim 7, wherein the second surface area of the display is an entire surface area of the display.
